(19) United States
(12) Patent Application Publication
(10) Pub. No.: US 2005/0278212 A1
(43) Pub. Date: Dec. 15, 2005

(54) Methods for the linear clustering and display of information

(76) Inventors: David P. Fan, St. Paul, MN (US); Regis S. Fan, Westminster, CO (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 11/124,410

(22) Filed: May 6, 2005

Related U.S. Application Data
(60) Provisional application No. 60/568,751, filed on May 6, 2004.

(51) Int. Cl. G06F 17/60

(52) U.S. Cl. 705/10; 705/1

(57) ABSTRACT

Systems, methods, and structures are described to support enhanced population analysis are discussed. The population includes individuals with each individual including a set of properties. The system of the present invention is useful for exploring population structure including individuals with missing values, individuals that are documents in databases, and individuals that are products and services sold using a computer display.

### RELATED APPLICATIONS

The present application claims the benefit of priority under 35 U.S.C. 119(e) of U.S. Provisional Patent Application 60/568751, filed May 6, 2004. The present disclosure is related to U.S. Provisional Patent Application 60/492,788, entitled, “METHODS FOR ENHANCING THE CREATION OF DOCUMENTS COMPOSED OF LINEAR SEQUENCES OF ITEMS,” filed Aug. 6, 2003.

### FIELD OF THE INVENTION

The technical field relates generally to field of data modeling and analysis, more specifically, systems, methods, displays, and structures for analyzing populations of individuals wherein each individual possesses a set of properties.

### COPYRIGHT NOTICE—PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent files or records, but otherwise reserves all copyright rights whatsoever. The following notice applies to the software and data as described below and in the drawings attached hereto: Copyright © 2004, David P. Fan and Regis S. Fan, All Rights Reserved.

### BACKGROUND

One problem with current methods of data analysis is inadequate handling of data with missing values. Consider a dataset comprised of a number of individuals wherein each individual possesses a number of properties. In many analytical methods, all information about an individual is discarded if a single property of an individual has a missing value. The problem is the loss of potentially important information in available values for other properties.

### SUMMARY

Systems, methods, and structures to support the enhanced analysis and display of population data. A population includes individuals with each individual having a set of properties. The system includes a population, communication means that allows access to information about the population, and a population-analysis engine generating linear arrays of properties and linear arrays of individuals. The method includes graphical displays of the arrays.

### BRIEF DESCRIPTION OF THE DRAWINGS

FIG. 1 is a display diagram of an example display according to one aspect of the present invention.

FIG. 2 is a display diagram of an example display according to one aspect of the present invention.

FIG. 3 is a display diagram of an example display according to one aspect of the present invention.

### DETAILED DESCRIPTION

In the following detailed description of exemplary embodiments of the invention, reference is made to the accompanying drawings which form a part hereof, and in which is shown, by way of illustration, specific exemplary embodiments in which the invention may be practiced. These embodiments are described in sufficient detail to enable those skilled in the art to practice the invention. Other embodiments may be utilized and structural, logical, electrical, and other changes may be made without departing from the spirit or scope of the present invention. The following detailed description is, therefore, not to be taken in a limiting sense, and the scope of the present invention is defined only by the appended claims.

The embodiments of the present invention focus on a system for population-analysis wherein a population includes individuals wherein each individual possesses a set of properties. The result of the analysis is a display hereinafter called an InfAlign map.

In the preferred embodiment, the application is to data from a public opinion survey. In the InfAlign map, every individual is shown as a series of horizontal line segments all aligned in a row. The line segments are arranged in columns. In the preferred embodiment, the columns are survey responses and the rows are the individuals.

In the preferred embodiment, all line segments are displayed on a uniform background in a background color. In one embodiment, a label for a column includes summary information including information derived from properties in the column. In the exemplary embodiment, the summary information is the sum of all individuals with values for the column that are both non-zero and not missing. At least one aspect of a line segment is used to indicate a feature of a property. In one embodiment, an aspect of a line segment is length. In one embodiment, an aspect of a line segment is shading. In one embodiment, an aspect of a line segment is color. In one embodiment, an aspect of a line segment is intensity of color. In one embodiment, an aspect of a line segment is style.

For a property with a missing value, an aspect of a line segment indicates missing. In the preferred embodiment, an aspect of a missing value is a line segment in a light color extending the full width of the column.

For a property with two binary states, called State1 and State2, an aspect of a line segment indicates the state. A line segment for an individual in State2 for a property is drawn as a dark line extending the full width of the column corresponding to the property. In one embodiment, a line segment for an individual in State1 for the property is drawn in the background color extending the full width of the column corresponding to the property. In one embodiment, a line segment for an individual in State1 for the property is not drawn. Drawing in the background color is equivalent to not drawing the line segment because the map has the same appearance in both cases. In one embodiment, a line segment for an individual in the corresponding column is drawn in a color to represent State1 extending the full width of the column if the state is State1.

For a property with quantitative values, an aspect of a line segment indicates the quantitative value. In one embodiment, statistical methods are used to provide conditions for displaying the property. In one embodiment, a statistical method is weighting. In one embodiment, a statistical method is the assessment of a minimum value. In one embodiment, a statistical method is the assessment of a maximum value. In the preferred embodiment, a dark line is drawn with length based on the mean and the standard deviation computed from the values of the column for all individuals in the population for which a value is available. The line segment for an individual extends from two standard deviations below the mean at the left edge of the column to two standard deviations above the mean at the right edge.

In the preferred embodiment, a line representing an individual is not associated with a label on the InfAlign map.

In an exemplary embodiment, the population was surveyed for opinion about the legal recognition of gay marriages (gayunion question).

The 19 properties tested as predictor properties were:

1. Responses to six question asking for opinion on gays relative to jobs (gayjob), housing (gayhouse), serving as clergy (gayclerg), the related question of women in the clergy (femclerg), clergy officiated wedding for gay marriages (gaywed), and the election of a gay Episcopal as bishop (gaybish).

2. Responses to three questions asking for opinion on marriage including a constitutional amendment to bar gay marriages (maramend), government promotion of marriage between a man and a woman (govmar), and whether marriage is a sacred covenant or a civil contract (marview).

3. Two properties relative to religious beliefs. One property was the responses to a question on the frequency of attendance at religious services (oftchrch). One property was a composite property quantifying the fundamentalism of religious beliefs (oldpar) based on responses to four related survey questions asking about belief in the literal truthfulness of the Bible, efforts to convert others to Christianity, being a “born again” or “Evangelical” Christian, and being a self-described “Fundamentalist” Christian.

4. Two political properties. One property was the position on an ideological scale ranging from liberal to conservative (libcon). One property was political party affiliation (partyaff).

5. Responses to six demographic questions including number of children (numkids), education (educ), the dichotomous distinction in race between white and all others (race), income (income), year born (yearborr), and gender (gender).

Among 311 respondents who responded with a non-missing value for gayunion, the property to be predicted, only 107 (34%) had non-missing values for all other properties, the predictor properties. Therefore, discarding individuals with at least one missing value leads to the removal of about two-thirds of the starting individuals.

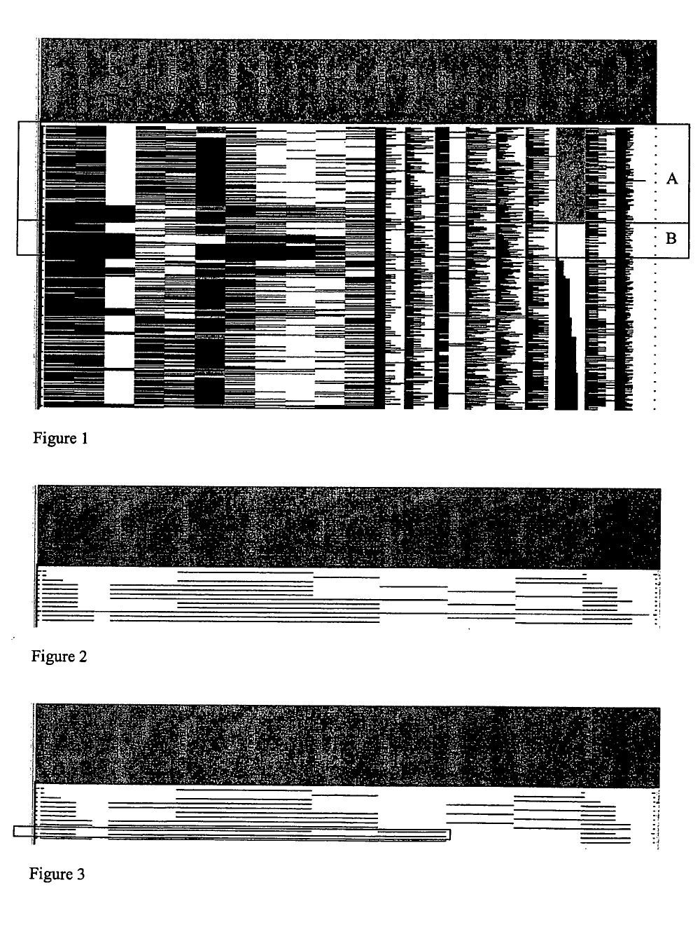

The Align map provides an efficient way to visualize the characteristics of the eliminated individuals (FIG. 1). All 311 individuals with a non-missing value for the gayunion question are mapped. To study the impact of missing values, the individuals were ordered hierarchically and sequentially.

1. The first key for the ordering was oldpar. All individuals with a missing oldpar value are shown in box A (FIG. 1) with light colored lines, one immediately below the other, with no gaps between the lines. Below the light colored zone of missing values, oldpar values increase in dark colored steps down the map because the oldpar property was constructed from binary responses so the ordering changed oldpar values by discrete quantities.

2. The second ordering key was gayunion, the property to be predicted.

3. The third ordering key was marview.

In one embodiment, the InfAlign map is used to predict predictor properties from the property to be predicted. In standard regression analyses, the goal is to use predictor properties to predict an outcome, in this case gayunion. The InfAlign map can lead to the reverse prediction. As an illustration, consider the pattern under the gayunion column.

Since the first ordering key, oldpar, moved in steps, there were zones of individuals all with the same oldpar. Within each zone, individuals were ordered by gayunion. In box A (FIG. 1), all people opposed to gay marriages are in the zone in the background color at the top of the gayunion column. All the proponents are in the dark colored region at the bottom of box A. There are no missing values in this column because the goal was to predict gayunion so only respondents with non-missing answers to this question are mapped.

A scan to the two columns of gayjob and gayhouse to the left of the gayunion column instantly shows that all respondents answering yes to gayunion also answered yes to gayjob and gayhouse. The reverse is not the case. Therefore, gayunion is a completely reliable predictor of the predictors gayjob or gayhouse.

In one embodiment, the prediction of predictors from the property to be predicted is used to identify target individuals for research or commerce. For example, a company can use the gayunion question to target people in the gay job domain without needing to ask the gayjob question.

In one embodiment, the InfAlign map provides information on dissimilarities based on individuals with missing values. Sometimes, it is possible to see how individuals not responding to a survey question differ from those that do. In the InfAlign map of FIG. 1, visual inspection of the gender column (seven columns to the left of the oldpar column) suggested that the density of darker color lines was lower in box A than in the entire region below this box. This visual inference was verified by counts which showed that the number of women and men in box A were 72 and 28 respectively to give a ratio of 2.57. In contrast, there were 106 women and 99 men in all the individuals below box A with a comparable ratio of 1.07.

Therefore, the InfAlign map suggested that women were less willing or able than men to respond to questions used for the oldpar scale of religious fundamentalism.

In one embodiment, the InfAlign map provides inferences about reasons for non-response. In the section just above, the InfAlign map of FIG. 1 suggested a gender difference among respondents but did not indicate why that difference should exist.

However, the InfAlign map can suggest an explanation as was true for the marview column. This column refers to the respondents' views on marriage as being either a sacred covenant (dark line) or a civil contract (background color). Since marview was the third key for the ordering, the marview responses are ordered within a set of zones, one for each oldpar cluster. These zones are delimited for the top two clusters in boxes A and B. Box A includes the missing values for oldpar, and box B includes the lowest measured values for oldpar corresponding to the least fundamentalist respondents. Equivalent boxes for the remaining groupings of individuals are not drawn to avoid adding clutter to the diagram.

Inspection of boxes A, B and equivalent boxes down the map shows that the marview column in most of these boxes have a broad light colored zone of lines at the top and a broad dark colored region of lines at the bottom with very few lines in the background color in between. Thus most people either answered that marriage was a sacred covenant or did not answer the question.

The main exceptions were the low fundamentalist subpopulations in box B and immediately below for which the civil contract answers (background color) outnumbered the missing values (light colored lines).

Therefore, the InfAlign map suggested that marriage as a civil contract was a novel concept that most individuals did not fully understand or appreciate. Many people with doubts about marriage being a sacred covenant chose not to answer rather than to say that marriage was a civil contract.

In one embodiment, the InfAlign map suggests is used to make reasoned predictor choices. Without focusing so closely on individual zones under individual columns as has been done so far, it is possible to view the map in FIG. 1 from an overview perspective.

Consider the entire map below box A thereby including all individuals with non-missing values for oldpar. In this lower two-thirds of the map, the density of dark colored lines generally decreases from top to bottom of the map for the five properties of gayjob, gayhouse, femclerg, gayclerg, and gaybish. In contrast, the two properties maramend and govmar both show increases in the dark colored lines. Since the order in this region is based on oldpar, the map suggests that oldpar should be good at predicting all seven of these predictor properties as well as the original property to be predicted gayunion that also decreases down the map. The same seven predictors should also be good predictors for oldpar. If oldpar is a good predictor of dependent variable gayunion, then the same seven predictors should also be good predictors.

In one embodiment, individuals are aligned such that individuals with high similarity are close together in a linear sequence of individuals. In one embodiment, a condition for similarity is a correlation of properties. In one embodiment, a condition of similarity is the probability that an individual is like another individual.

In one embodiment, individuals are products designed for sale through e-commerce using displays on computer screens. Characteristics of individual products are presented as columns. All the properties of a product are presented as line segments in a row. FIG. 2 shows an exemplary embodiment in which the screen displays an InfAlign map proposing meals available for purchase. The ingredients are described in the columns. Individual meal choices are the horizontal lines.

In one embodiment, an InfAlign map includes a summary property summarizing information from at least one property. The exemplary embodiment includes a summary column called Ingredients computed as the sum of the number of ingredients in a meal.

In one embodiment, a property of an individual, such as an ingredient of a meal, is deduced from information in the form of text.

In one exemplary embodiment, the user selects a computer menu item to obtain meals sorted by increasing price as is seen in FIG. 2.

In one embodiment, a computer cursor has the form of a line (light colored line in FIG. 2) that overlaps all the line segments corresponding to an individual. In the exemplary embodiment of FIG. 2, the cursor line indicates all the ingredients of a particular meal along with the cost and the total number of ingredients.

In one embodiment, the user selects the cursor line and the computer displays a more complete description of the meal:

| | |
|---|---|
| Meal number | 1 |
| Price | $5.00 |
| Lettuce | Romaine |
| Tomato | Locally grown |
| Onion | Red |
| Bread | Rye |
| Ham | Glazed |
| Chicken | None |
| Fish | None |
| Total ingredients | 5 |

In one exemplary embodiment, the user selects a computer menu item to instruct the computer to sort the meals by ham and, within the meals including ham, by price. The computer responds by presenting an InfAlign map with the meals sorted by the ham and price keys as is shown in FIG. 3. The user now can focus on meals containing ham in the desired price range in preparation for making a purchase.

In one exemplary embodiment, the user selects a portion of a computer screen as is shown by the box in FIG. 3. The computer responds by presenting detailed information for all the individuals with at least a portion of a line segment in the selected region.

In one exemplary embodiment, the user selects a portion of a computer screen as is shown by the box in FIG. 3. The computer responds by modifying the display of the InfAlign map. In one embodiment, the computer places larger spaces between the lines in the selected region.

In one embodiment, the InfAlign map is turned 90 degrees such that the columns and rows are interchanged.

In one embodiment, the InfAlign map is used to present the results of a search of information available through the World Wide Web. In one embodiment, the Infalign map is used to present the results of a database search. In one embodiment, the database search results include references to documents. In one embodiment, the database search results include content material from documents. In one embodiment, the database search results include information in technical domains. In one embodiment, the database search results include medical information. In one embodiment, the database search results include legal data. In one embodiment, the database search results in information about commercial products in preparation for purchase.

In one embodiment, the InfAlign map is constructed from a sample of available individuals. In one embodiment, the sample is a random sample. In one embodiment, examination of the random sample leads a user to select an alternate sample of individuals.

In one embodiment, the cursor includes a line covering the same property for a plurality of individuals.

In one embodiment, the InfAlign map is used to display individuals and properties with the orders of individuals and properties generated by at least one method specified by a user.

### CONCLUSION

Systems, methods, and structures have been discussed to enhance population-analysis by displaying individuals and their properties in linear sequences. Although the specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. It is to be understood that the above description is intended to be illustrative, and not restrictive. Combinations of the above embodiments and other embodiments will be apparent to those of skill in the art upon reviewing the above description. The scope of the invention includes any other applications in which the above structures and fabrication methods are used. Accordingly, the scope of the invention should only be determined with reference to the appended claims, along with the full scope of equivalences to which such claims are entitled.

1. A method of population-analysis wherein:
the properties of individuals are displayed as a series of line segments aligned in a row wherein the lengths of the line segments provide quantitative information about the properties, and
wherein missing values are indicated by lines with at least one characteristic indicating the idea of missing.

2. A method of population-analysis wherein:
the properties of individuals are deduced from text, and
the properties of individuals are displayed as a series of line segments aligned in a row wherein the lengths of the line segments provide quantitative information about the properties.

3. A method of population-analysis wherein:
the individuals are products or services in the domain of commerce, and
the properties of individuals are displayed as a series of line segments aligned in a row wherein the lengths of the line segments provide quantitative information about the properties.

4. A method of population-analysis wherein:
the properties of individuals are displayed as a series of line segments aligned in a row wherein the lengths of the line segments provide quantitative information about the properties,
an individual is selected using a cursor line that follows a plurality of properties of an individual, and
the result is a display of detailed properties of the individual.

5. A method of population-analysis wherein:
the properties of individuals are displayed as a series of line segments aligned in a row wherein the lengths of the line segments provide quantitative information about the properties,
a plurality of individuals is selected using markings on the display able to indicate the plurality of individuals, and
the result is a change in the appearance of an InfAlign map.
